(19) United States
(12) Patent Application Publication
(10) Pub. No.: US 2024/0405987 A1
(43) Pub. Date: Dec. 5, 2024

(54) Managing Access To Content In A Distributed Context Network

(71) Applicant: QUALCOMM Incorporated, San Diego, CA (US)

(72) Inventors: Abhinav SHANKAR, Coimbatore (IN); Anwesha NAYAK, Jajpur (IN); Kiran Anil CHIKODI, Belagavi (IN); Sidhartha Kumar KAR, Hyderabad (IN); Greeshmalatha VALLURY, Hyderabad (IN); Vasavi KANCHARLA, Hyderabad (IN); Aminul ISLAM, Kharupetia (IN); Pankaj MULCHANDANI, Raipur (IN); Vasudev SENAPATI, Hyderabad (IN); Shashi Vardhan KONATHAM, Hyderabad (IN); Manjil Kumar CHOUDHURY, Hyderabad (IN)

(21) Appl. No.: 18/326,061

(22) Filed: May 31, 2023

(51) Int. Cl. H04L 9/32; H04L 9/40

(52) U.S. Cl. CPC H04L 9/321; H04L 63/102

(57) ABSTRACT

Methods managing access to content in a distributed context network may include, storing, by a first computing device, content to a copy buffer in the first computing device, in which the content is associated with a user key and an encrypted content address, receiving a request from a second computing device for selected content from among the content, wherein the request includes a purported user key, performing an authentication operation, by the first computing device, using the user key associated with the selected content and the purported user key, sending to the second computing device an authentication success message in response to performing the authentication successfully, and providing the selected content to the second computing device in response to an access attempt by the second computing device to obtain the selected content.

### BACKGROUND

Content sharing between computing devices connected to a network may be accomplished with a copy buffer. However, navigating through a copy buffer that is visible and available to all connected computing devices to copy content from one device to another device in a network with many connected computing devices is a laborious and tedious task. Further, storing sensitive or confidential information in a copy buffer available to all connected device poses a security risk for such information.

### SUMMARY

Various aspects include methods that may be implemented on a processor of a computing device for managing access to content in a distributed context network. Various aspects may include storing, by a first computing device, content to a copy buffer in the first computing device, wherein the content is associated with a user key and an encrypted content address, receiving a request from a second computing device for selected content from among the content, wherein the request includes a purported user key, performing an authentication operation, by the first computing device, using the user key associated with the selected content and the purported user key, sending to the second computing device an authentication success message in response to performing the authentication successfully, and providing the selected content to the second computing device in response to an access attempt by the second computing device to obtain the selected content. Some aspects may further include sending to the second computing device the user key associated with the content.

In some aspects the authentication success message may further include information configured to enable the second computing device to decrypt the encrypted content address. In some aspects, providing the selected content to the second computing device in response to the access attempt by the second computing device to obtain the selected content may include: receiving the access attempt comprising a decrypted content address; and providing the selected content to the second computing device in response to the access attempt comprising the decrypted content address.

In some aspects providing the selected content to the second computing device in response to the access attempt by the second computing device to obtain the selected content may include: receiving a request for the selected content from the second computing device; decrypting the encrypted content address; and sending to the second computing device the selected content using the decrypted content address.

Some aspects may further include sending an indication of the content stored in the copy buffer in the first computing device in state information sent by the first computing device to the second computing device via the distributed context network.

Further aspects may include a processor for use in a computing device configured to perform operations of any of the methods summarized above. Further aspects may include a computing device including means for performing functions of any of the methods summarized above. Further aspects may include a computing device configured with processor-executable instructions to perform operations of any of the methods summarized above.

Various aspects include further methods that may be implemented on a processor of a computing device for managing access to content in a distributed context network. Various aspects may include receiving, by a first computing device, a user key that is associated with content stored in a second computing device, sending a request to the second computing device for selected content from among the content stored in the second computing device, wherein the request includes a purported user key that is based on the received user key and is configured to enable the second computing device to perform an authentication operation using the purported user key, performing an access attempt to obtain the selected content, and receiving from the second computing device the selected content in response to the access attempt.

In some aspects, receiving the user key that is associated with the content stored in the copy buffer in the second computing device may include receiving the user key in a message from the second computing device. In some aspects, receiving the user key that is associated with the content stored in the copy buffer in the second computing device may include receiving the user key via a user input to the first computing device.

Some aspects may further include presenting a user interface indicating the content stored in the copy buffer in the second computing device; and receiving by the first computing device an input indicating the selected content. Some aspects may further include storing the received selected content or presenting the received selected content via a user interface.

Further aspects may include a processor for use in a computing device configured to perform operations of any of the methods summarized above. Further aspects may include a computing device including means for performing functions of any of the methods summarized above. Further aspects may include a computing device configured with processor-executable instructions to perform operations of any of the methods summarized above.

### BRIEF DESCRIPTION OF THE DRAWINGS

The accompanying drawings, which are incorporated herein and constitute part of this specification, illustrate example embodiments, and together with the general description given above and the detailed description given below, serve to explain the features of various embodiments.

FIG. 1 is a system block diagram illustrating an example communications system suitable for implementing various embodiments.

FIG. 2 is a component block diagram illustrating an example computing system including a wireless modem suitable for implementing various embodiments.

FIG. 3 is a component block diagram illustrating a system configured to enable managing access to content in a distributed context network in accordance with various embodiments.

FIG. 4 is a component block diagram illustrating a system configured to enable managing access to content in a distributed context network in accordance with various embodiments.

FIG. 5 is a message flow diagram illustrating an example method that may be performed by a processing device of a computing device for managing access to content in a distributed context network in accordance with various embodiments.

FIG. 6A is a process flow diagram illustrating a method that may be performed by a processing device of a computing device for managing access to content in a distributed context network in accordance with various embodiments.

FIGS. 6B-6D are process flow diagrams illustrating example operations that may be performed by a processing device of a computing device as part of the method for managing access to content in a distributed context network in accordance with various embodiments.

FIG. 7A is a process flow diagram illustrating a method that may be performed by a processing device of a computing device for managing access to content in a distributed context network in accordance with various embodiments.

FIGS. 7B and 7C are process flow diagrams illustrating example operations that may be performed by a processing device of a computing device as part of the method for managing access to content in a distributed context network in accordance with various embodiments.

FIGS. 8-10 are component block diagrams of example computing devices suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes, and are not intended to limit the scope of the claims.

Various embodiments include methods that may be implemented on a processor of a computing device for managing access to content in a distributed context network. In some embodiments, a first computing device that is in communication with the distributed content network may save content to a copy buffer on the first computing device. The saved content may be associated with an identifier having at least two elements, a user key and an encrypted content address. A second computing device that is in communication with the distributed content network may receive the user key. In some embodiments, the second computing device may receive the user key directly, for example via a user input received at the second computing device. In some embodiments, the second computing device may receive the user key in a message that is sent from the first computing device via the distributed context network. The second computing device may send a request via the distributed context network for content selected from the content and the copy buffer on the first computing device. The request from the second computing device may include the user key. The first computing device may perform an authentication operation using the user key received in the request and the user key associated in the first computing device with the selected content. In response to performing a successful authentication operation, the first computing device may perform an operation to enable the second computing device to obtain the selected content. The second computing device may receive the selected content from the first computing device, and may perform an operation using the received selected content, such as storing the received selected content, or presenting the receive selected content via a user interface.

As used herein, the term “computing device” refers to an electronic device equipped with at least a processor, memory, and wireless communication devices such as a transceiver and antenna configured to enable communication with wireless communication devices and networks. A computing device may include any one or all of smart glasses, augmented/virtual reality devices, cellular telephones, smartphones, portable computing devices, personal or mobile multi-media players, laptop computers, tablet computers, 2-in-1 laptop/table computers, smart-books, ultrabooks, multimedia Internet-enabled cellular telephones, wearable devices including smart-watches and smart-contact lenses, entertainment devices (e.g., wireless gaming controllers, music and video players, satellite radios, etc.), and similar electronic devices that include a memory, wireless communication components and a programmable processor. As used herein, the term “smart” in conjunction with a device, refers to a device that includes a processor for automatic operation, for collecting and/or processing of data, and/or may be programmed to perform all or a portion of the operations described with regard to various embodiments. Non-limiting examples of a smart device include a smart phone, smart glasses, smart contact lenses, a smart watch, a smart ring, a smart necklace, a smart cup, a smart straw, smart appliances, and other suitable devices.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single wireless device. The proximity of the SOCs facilitates high speed communications and the sharing of memory and resources.

As used herein, the terms “component,” “system,” “unit,” “module,” and the like include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

Content sharing between computing devices connected to a network may be accomplished with a copy buffer. For example, many computing devices may be in communication with a distributed context network, and at least one of such computing devices may store content that the storing computing device has made available for access by one or more other connected computing devices. In some embodiments, the copy buffer may be a data structure in which a copy of content may be stored, and from which one or more computing devices may access the stored content. For example, a first computing device connected to the distributed context network may have content stored in a memory of the first computing device, and also may store a copy of at least some of the content in a copy buffer that is on the first computing device. In this manner, the first computing device may control what of its content is made available for access by another computing device.

In some cases, one user may have several computing devices in communication with the distributed context network, in which each of the computing devices is associated with the user. Such a user may copy content from such computing device to another of the user's computing devices via the distributed context network. In other cases, computing device may be configured with a content buffer that stores content copied from the computing device and made available by the computing device for access (e.g., copying, viewing, streaming, etc.) by another connected computing device via the distributed context network.

However, implementing a copy buffer that is visible and available to all computing devices poses a variety of challenges. A second computing device connected to the distributed context network may display an indication (e.g., via a user interface) of all of such content. Navigating through a copy buffer that is visible and available to all connected computing devices is a laborious and tedious task. Additionally, some of the content stored in a copy buffer may be sensitive or confidential. For example, a user having multiple computing devices connected to the distributed context network may store sensitive information (e.g., a one-time password for access to an application or service) in the content buffer for copying from one of the user's computing devices to another of the user's computing devices. However, such sensitive information stored in the copy buffer may be accessible to all connected devices. In implementations, in which the copy buffer is visible and available to all computing devices on the distributed context network, storing sensitive or confidential information in the copy buffer poses a security risk for such information.

Various embodiments include methods of managing access to content in a distributed context network that may be performed in a processor of a first computing device, such as a computing device configured with a copy buffer. The first computing device may store content to the copy buffer in the first computing device. The content stored in the copy buffer may be associated with a user key and an encrypted content address. In some embodiments, the user key and the encrypted content address associated with the stored content may be configured as data grouped in a set, such as a data pair (e.g., [user key, encrypted content address]). The user key and the encrypted content address also may be grouped with additional information, for example a device identifier of the first computing device, a content identifier of the content, a content type identifier, and/or other suitable information.

In some embodiments, the user key may be an authentication factor or authentication information associated with a user. For example, the user key associated with content stored in the copy buffer in the first computing device may be associated with a user of the first computing device. In some embodiments, the user key may be biometric information of the user, such as a fingerprint or face identification (face ID). In some embodiments, the user key may be alphanumeric information, such as a personal identification number (PIN), a password, or other user-identifying information. In some embodiments, the user may have two or more computing devices connected to the distributed context network, and the user key may be usable on all of the user's computing devices to identify the user (vs. the device) who copies a file to a computing device's copy buffer.

In some embodiments, computing devices connected to the distributed context network may from time to time transmit state information to other computing devices connected to the distributed context network. In some embodiments, the first computing device may send an indication of the contents stored in the copy buffer in the first computing device in such state information. In some embodiments, such state information may be configured according to a protocol of the distributed context network. In some embodiments, another computing device connected to the distributed context network (a second computing) device may receive the indication of the content stored in the copy buffer in the first computing device, and may present a user interface indicating the stored content. In some embodiments, the indication of the content stored in the copy buffer in the first computing device may include or may be associated with the encrypted content address.

In some embodiments, the second computing device may receive the user key that is associated with the stored content in the copy buffer in the first computing device. The second computing device may receive the user key in various manners. In some embodiments, the first computing device may send the user key associated with the content to the second computing device in a message via the distributed context network. For example, the first computing device may send a message indicating that the first computing device grants permission to the second computing device to view (or access) content stored in the copy buffer on the first computing device. In some embodiments, the second computing device may receive the user key via a user input to the second computing device. For example, a user may input the user's biometric information, PIN, password, or other information of the user key to the second computing device via an input device, touchscreen, scanner, sensor, or another suitable device.

As noted above, in some embodiments, the second computing device may receive the indication of the content stored in the copy buffer in the first computing device, and may present a user interface indicating the stored content. In some embodiments, the second computing device may be configured to present in the user interface stored content that is associated with a received user key. For example, the second computing device may receive an indication of content stored in the copy buffer in the first computing device, and an indication of other content stored in a copy buffer in a third computing device that is connected to the distributed context network. If the second computing device has received user key associated with the content stored in the first computing device's copy buffer, the second computing device may present in a user interface an indication of the content stored in the first computing device's copy buffer. However, if, for example, the second computing device has not received a user key associated with the content stored in the third computing device's copy buffer, the second computing device may not present in the user interface an indication of the content stored in the third computing device's copy buffer.

The second computing device may receive an input indicating a selection of content stored in the first computing device's copy buffer (selected content). The second computing device may send a request for the selected content to the first computing device. In some embodiments, the request from the second computing device may include information purporting to be the user key (a purported user key).

The first computing device may perform an authentication operation using the user key associated with the selected content and the purported user key received from the second computing device. For example, the first computing device may determine whether the purported user key received from the second computing device matches the user key associated in the copy buffer in the first computing device with the selected content. As another example, the first computing device may determine whether the hash value of the purported user key matches a hash value of the user key associated with the selected content. As another example, the first computing device may apply the purported user key in the user key associated with the selected content to a cryptographic algorithm to authenticate the purported user key.

In response to performing the authentication successfully, the first computing device may send to the second computing device an authentication success message. After receiving the authentication success message, the second computing device may perform an access attempt to obtain the selected content from the copy buffer in the first computing device.

In some embodiments, the authentication success message may include information configured to enable the second computing device to decrypt the encrypted content address. In such embodiments, the second computing device may use the decrypted content address to perform the access attempt for the selected content. For example, the second computing device may send a request or command that includes or uses the decrypted content address to access the selected content. In response to the access attempt that uses or includes the decrypted content address, the first computing device may provide the selected content to the second computing device, or may permit the second computing device access to the selected content.

In some embodiments, the authentication success message may not include the information configured to enable the second computing device to decrypt the encrypted content address. In such embodiments, having received the authentication success message, the second computing device may send a request for the selected content to the first computing device. In response to receiving the request for the selected content, the first computing device may decrypt the encrypted content address, may access the selected content using the decrypted content address, and may send to the second computing device the selected content.

The second computing device may perform an operation using the received selected content. In some embodiments, the second computing device may store the received selected content. In some embodiments, the second computing device may present the received selected content via a user interface (e.g., displaying the received content, playing an audio portion of the received content, etc.).

Various embodiments improve the utility and security of computing devices connected to a distributed content network by enabling a computing device to manage access via a distributed content network to content stored in a copy buffer.

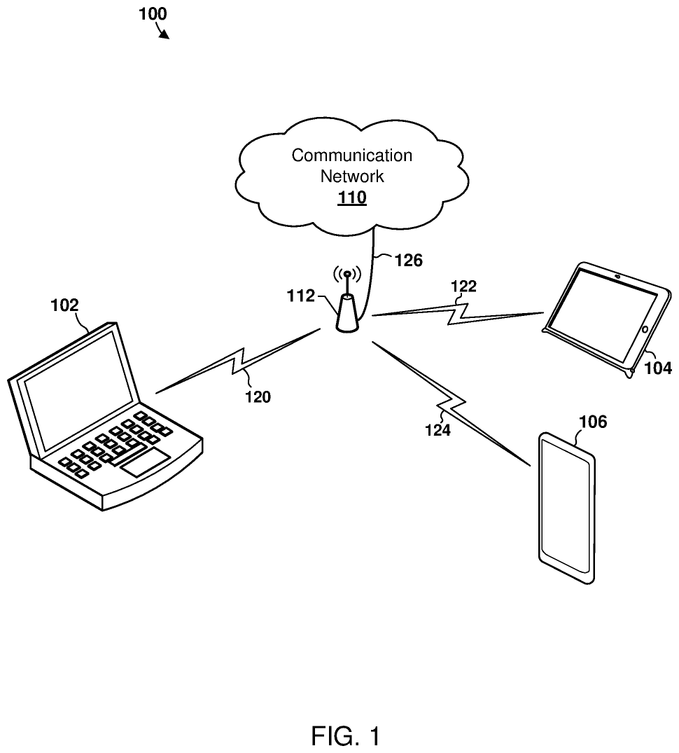

FIG. 1 is a system block diagram illustrating an example communications system 100 suitable for implementing various embodiments. The example communication system 100 may include a first computing device 102, a second computing device 104, a third computing device 106, an access point 112 that supports wireless communications 120, 122, 124 among the connected computing devices and provides access to a communication network 110 such as the Internet. While the example communications system 100 is illustrated as including three computing devices, such a system will typically include many more devices that are not shown in FIG. 1, including for example smart televisions, voice-activated interfaces (e.g., Alexa® devices), smart speakers, smart thermostats, and the like.

The computing devices 102, 104, and 106 may each communicate with each other via the communication network 110. The computing devices 102, 104, and 106 may include radio frequency (RF) circuitry and an antenna to enable wireless communication with the communication network 110 via an access point 112 over wireless communication links 120, 122, 124. The access point 112 may communicate with the communication network 110 via a communication link 126. Each of the computing devices 102, 104, 106 may send and receive messages from the other computing devices that enable the computing devices 102, 104, 106 to participate in a distributed context network. Each of the computing devices 102, 104, 106 may be configured with a copy buffer. For example, each of the computing devices 102, 104, 106 may send and receive messages including information about computing device status, computing device operations, and information about content that is stored in a computing device's copy buffer, among other things. Each of the computing devices 102, 104, 106 may be configured to send and receive information via the communication network 110 and to send and receive information configured to enable the computing devices 102, 104, 106 to access content stored in another computing device's copy buffer.

While the computing devices 102, 104, and 106 are illustrated as a laptop computer, a tablet computing device, and a cell phone, these illustrations are merely exemplary and are not limitations on the forms or functions of the computing devices 102, 104, and 106.

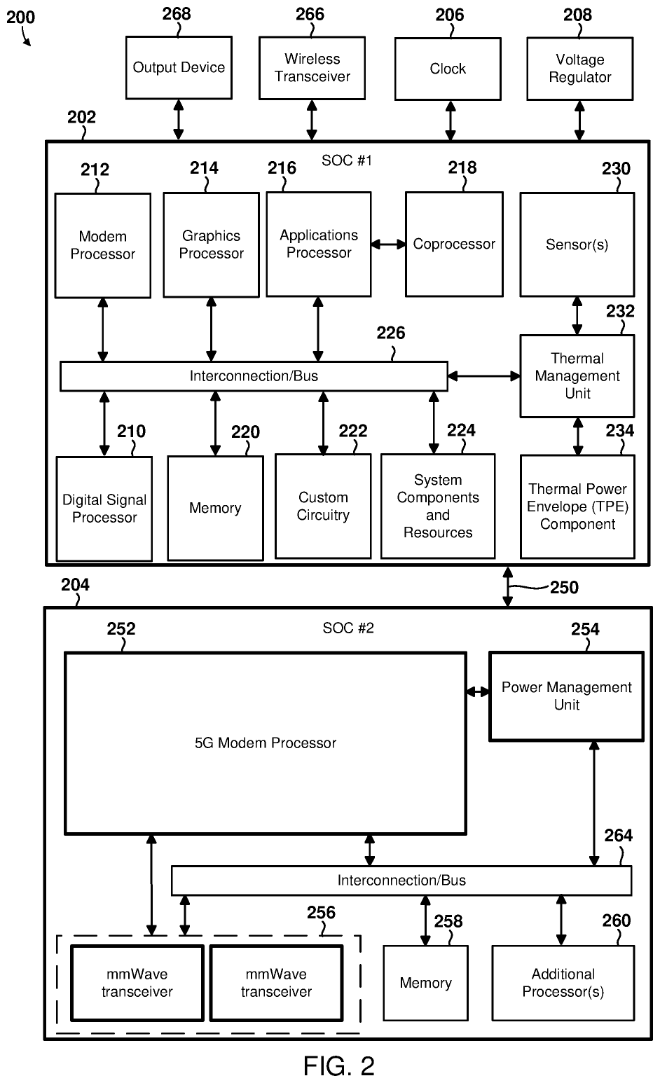

FIG. 2 is a component block diagram illustrating an example computing system 200 including a wireless modem suitable for implementing various embodiments. With reference to FIGS. 1 and 2, the illustrated example processing system 200 includes two SOCs 202, 204, a clock 206, a voltage regulator 208, a wireless transceiver 266, and a an output device 268 such as a display device, a sound output device (e.g., a speaker), a haptic feedback device, etc. In some embodiments, the first SOC 202 operates as central processing unit (CPU) of the wireless device that carries out the instructions of software application programs by performing the arithmetic, logical, control and input/output (I/O) operations specified by the instructions. In some embodiments, the second SOC 204 may operate as a specialized processing unit. For example, the second SOC 204 may operate as a specialized 5G processing unit responsible for managing high volume, high speed (e.g., 5 Gbps, etc.), and/or very high frequency short wavelength (e.g., 28 GHz millimeter wave (mmWave) spectrum, etc.) communications.

The first SOC 202 may include a digital signal processor (DSP) 210, a modem processor 212, a graphics processor 214, an application processor 216, one or more coprocessors 218 (e.g., vector co-processor) connected to one or more of the processors, memory 220, custom circuitry 222, system components and resources 224, an interconnection/bus module 226, one or more sensors 230 (e.g., thermal sensors, motion sensors, proximity sensors, a multimeter, etc.), a thermal management unit 232, and a thermal power envelope (TPE) component 234. The second SOC 204 may include a 5G modem processor 252, a power management unit 254, an interconnection/bus module 264, memory 258, and various additional processors 260, such as an applications processor, packet processor, etc. The second SOC 204 may further be coupled to a plurality of mmWave transceivers 256, which may be separate integrated circuits that are radio frequency shielded on or packaged separate from the second SOC 204 as indicated by the dashed line.

Each processor 210, 212, 214, 216, 218, 252, 260 may include one or more cores, and each processor/core may perform operations independent of the other processors/cores. For example, the first SOC 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 210, 212, 214, 216, 218, 252, 260 may be included as part of a processor cluster architecture (e.g., a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 and/or custom circuitry 222 may also include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (e.g., clock 206, voltage regulator 208) may be shared by two or more of the internal SOC processors/cores.

In addition to the example processing system 200 discussed above, various embodiments may be implemented in a wide variety of computing systems, which may include a single processor, multiple processors, multicore processors, or any combination thereof. In some embodiments, only one SOC (e.g., 202, 204) may be used in a less capable computing device that are configured to provide sensor information to a more capable computing device, such as a computing device 102, 104, 106.

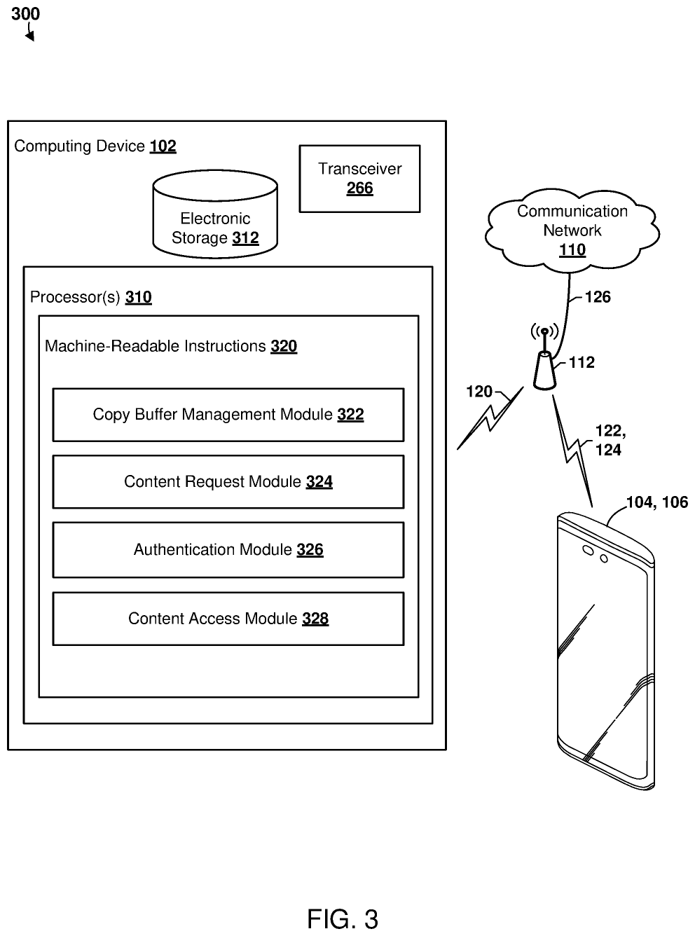

FIG. 3 is a component block diagram illustrating a system 300 configured to enable managing access to content in a distributed context network in accordance with various embodiments. With reference to FIGS. 1-3, the system 300 may include a computing device (e.g., 102), another computing device (e.g., 104, 106), communication network 110, and access point 112.

The computing device 102 may include one or more processors 310, electronic storage 412, a transceiver 266 (e.g., wireless transceiver), and other components. The computing device 102 may include a plurality of hardware, software, and/or firmware components operating together to provide the functionality attributed herein to the computing device 102.

Electronic storage 312 may include non-transitory storage media that electronically stores information. The electronic storage media of electronic storage 412 may include one or both of system storage that is provided integrally (i.e., substantially non-removable) with the computing device 102 and/or removable storage that is removably connectable to the computing device 102 via, for example, a port (e.g., a universal serial bus (USB) port, a firewire port, etc.) or a drive (e.g., a disk drive, etc.). In various embodiments, electronic storage 312 may include one or more of electrical charge-based storage media (e.g., EEPROM, RAM, etc.), solid-state storage media (e.g., flash drive, etc.), optically readable storage media (e.g., optical disks, etc.), magnetically readable storage media (e.g., magnetic tape, magnetic hard drive, floppy drive, etc.), and/or other electronically readable storage media. Electronic storage 312 may include one or more virtual storage resources (e.g., cloud storage, a virtual private network, and/or other virtual storage resources). Electronic storage 312 may store software algorithms, information determined by processor(s) 310, information received from the computing devices 102, 104, 106, and/or other information that enables the computing device 102 to function as described herein.

Processor(s) 310 may include one of more local processors (e.g., 210, 212, 214, 216, 218, 260), which may be configured to provide information processing capabilities in the computing device 102. As such, processor(s) 310 may include one or more of a digital processor, an analog processor, a digital circuit designed to process information, an analog circuit designed to process information, a state machine, and/or other mechanisms for electronically processing information. Although processor(s) 310 is shown in FIG. 3 as a single entity, this is for illustrative purposes only. In some embodiments, processor(s) 310 may include a plurality of processing units. These processing units may be physically located within the same device, or processor(s) 310 may represent processing functionality of a plurality of devices operating in coordination.

The computing device 102 may be configured by machine-readable instructions 320, which may include one or more instruction modules. The instruction modules may include computer program modules. In various embodiments, the instruction modules may include one or more of a copy buffer management module 322, a content request module 324, an authentication module 326, and a content access module 328.

The copy buffer management module 322 may be configured to store content to a copy buffer in the computing device 102 (e.g., in the electronic storage 312). The stored content may be associated with a user key and an encrypted content address. In some embodiments, the copy buffer management module 322 may be configured to send to the second computing device (e.g., 104, 106) the user key associated with the content stored in the copy buffer.

The content request module 324 may be configured to receive a request from a second computing device (e.g., 104, 106) for selected content from among the content stored in the copy buffer. In some embodiments, the request may include a purported user key (information purporting to be the user key). In some embodiments, The content request module 324 may be configured to receive an access attempt that includes a decrypted content address from the second computing device.

The authentication module 326 may be configured to perform an authentication operation using the user key associated with the selected content and the purported user key. The authentication module 326 may be configured to send to the second computing device an authentication success message in response to performing the authentication successfully. In some embodiments, the authentication success message may include information configured to enable the second computing device to decrypt the encrypted content address.

The content access module 328 may be configured to provide the selected content to the second computing device in response to an access attempt by the second computing device to obtain the selected content. The content access module 320 may be configured to provide the selected content to the second computing device in response to an access attempt that includes a decrypted content address.

The processor(s) 310 may be configured to execute the modules 322-328 and/or other modules by software, hardware, firmware, some combination of software, hardware, and/or firmware, and/or other mechanisms for configuring processing capabilities on processor(s) 310. The description of the functionality provided by the different modules 322-328 is for illustrative purposes, and is not intended to be limiting, as any of modules 322-328 may provide more or less functionality than is described. For example, one or more of modules 322-328 may be eliminated, and some or all of its functionality may be provided by other ones of modules 322-328. As another example, processor(s) 310 may be configured to execute one or more additional modules that may perform some or all of the functionality attributed below to one of modules 322-328.

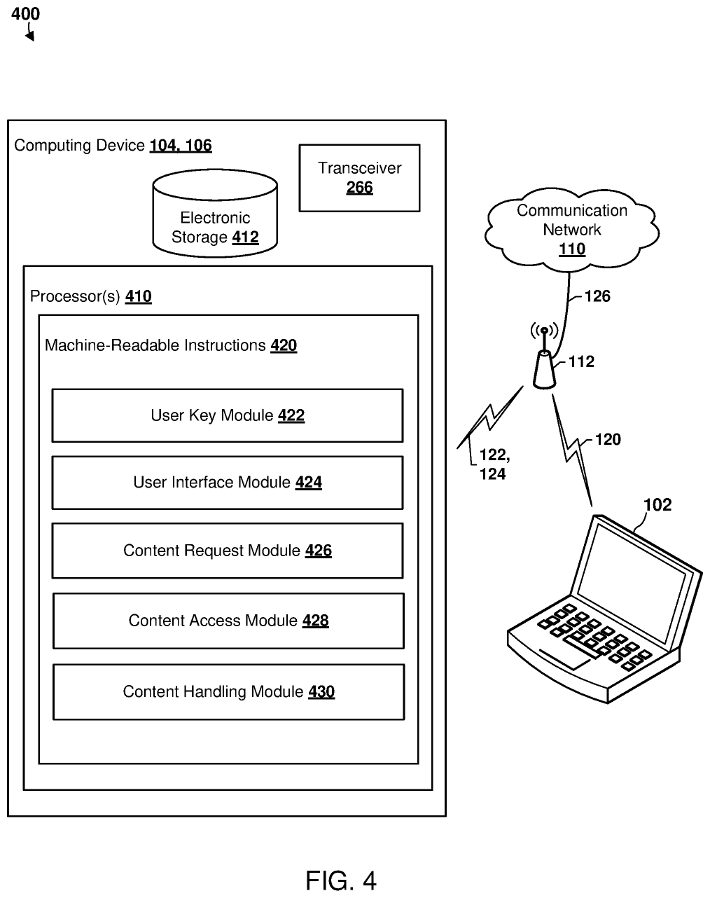

FIG. 4 is a component block diagram illustrating a system 400 configured to enable managing access to content in a distributed context network in accordance with various embodiments. With reference to FIGS. 1-4, the system 400 may include a computing device (e.g., 104, 106), another computing device (e.g., 102), communication network 110, and access point 112.

The computing device 104, 106 may include one or more processors 410, electronic storage 412, a transceiver 266 (e.g., wireless transceiver), and other components. The computing device 104, 106 may include a plurality of hardware, software, and/or firmware components operating together to provide the functionality attributed herein to the computing device 104, 106.

Electronic storage 412 may include non-transitory storage media that electronically stores information. The electronic storage media of electronic storage 412 may include one or both of system storage that is provided integrally (i.e., substantially non-removable) with the computing device 104, 106 and/or removable storage that is removably connectable to the computing device 104, 106 via, for example, a port (e.g., a universal serial bus (USB) port, a firewire port, etc.) or a drive (e.g., a disk drive, etc.). In various embodiments, electronic storage 412 may include one or more of electrical charge-based storage media (e.g., EEPROM, RAM, etc.), solid-state storage media (e.g., flash drive, etc.), optically readable storage media (e.g., optical disks, etc.), magnetically readable storage media (e.g., magnetic tape, magnetic hard drive, floppy drive, etc.), and/or other electronically readable storage media. Electronic storage 412 may include one or more virtual storage resources (e.g., cloud storage, a virtual private network, and/or other virtual storage resources). Electronic storage 412 may store software algorithms, information determined by processor(s) 410, information received from the computing devices 102, 104, 106, and/or other information that enables the computing device 104, 106 to function as described herein.

Processor(s) 410 may include one of more local processors (e.g., 210, 212, 214, 216, 218, 260), which may be configured to provide information processing capabilities in the computing device 104, 106. As such, processor(s) 410 may include one or more of a digital processor, an analog processor, a digital circuit designed to process information, an analog circuit designed to process information, a state machine, and/or other mechanisms for electronically processing information. Although processor(s) 410 is shown in FIG. 4 as a single entity, this is for illustrative purposes only. In some embodiments, processor(s) 410 may include a plurality of processing units. These processing units may be physically located within the same device, or processor(s) 410 may represent processing functionality of a plurality of devices operating in coordination.

The computing device 104, 106 may be configured by machine-readable instructions 420, which may include one or more instruction modules. The instruction modules may include computer program modules. In various embodiments, the instruction modules may include one or more of a user key module 422, a user interface module 424, a content request module 426, a content access module 428, and a content handling module 430.

The user key module 422 may be configured to receive a user key that is associated content stored in a copy buffer in the other (second) computing device 102. In some embodiments, the user key module 422 may receive the user key in a message from the second computing device 102. In some embodiments, the user key module 422 may be configured to receive the user key via an input to the computing device 104, 106.

The user interface module 424 may be configured to present a user interface indicating the content stored in the copy buffer in the second computing device 102. The user interface module 424 may be configured to receive an input indicating selected content.

The content request module 426 may be configured to send a request to the second computing device 102 for selected content from among the content stored in the copy buffer. In some embodiments, the request may include a purported user key that is based on the received user key and is configured to enable the second computing device to perform an authentication operation using the purported user key.

The content access module 428 may be configured to perform an access attempt to obtain the selected content in the copy buffer.

The content handling module 430 may be configured to receive from the second computing device 102 the selected content in response to the access attempt. The content handling module 430 may be configured to store the received selected content. The content handling module 430 may be configured to present the received selected content via a user interface (e.g., displaying the received content, playing an audio portion of the received content, etc.).

The processor(s) 410 may be configured to execute the modules 422-430 and/or other modules by software, hardware, firmware, some combination of software, hardware, and/or firmware, and/or other mechanisms for configuring processing capabilities on processor(s) 410. The description of the functionality provided by the different modules 422-430 is for illustrative purposes, and is not intended to be limiting, as any of modules 422-430 may provide more or less functionality than is described. For example, one or more of modules 422-430 may be eliminated, and some or all of its functionality may be provided by other ones of modules 422-430. As another example, processor(s) 410 may be configured to execute one or more additional modules that may perform some or all of the functionality attributed below to one of modules 422-430.

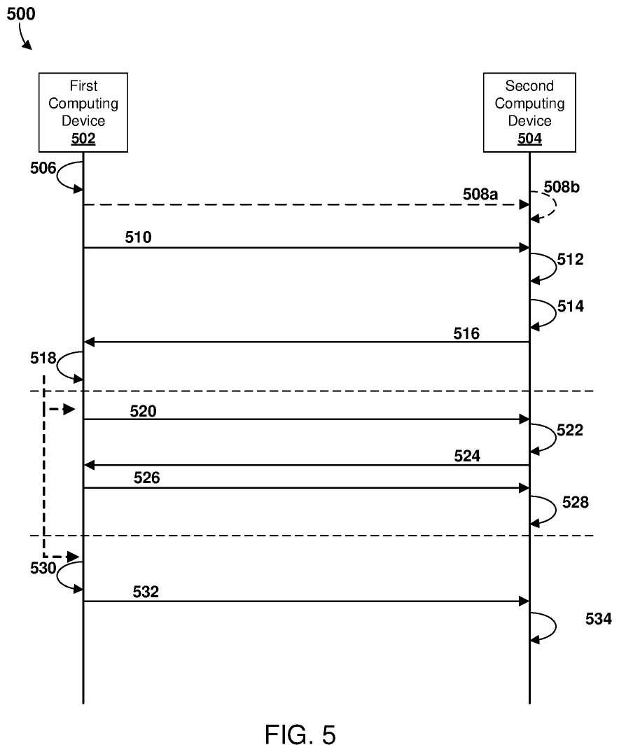

FIG. 5 is a message flow diagram illustrating an example method 500 that may be performed by a processing device of a computing device (e.g., 102, 104, 106) for managing access to content in a distributed context network in accordance with various embodiments. With reference to FIGS. 1-5, means for performing each of the operations of the method 500 may include a processor (e.g., 202, 204, 210, 212, 214, 216, 218, 260, 310) of the computing devices (e.g., 102, 104, 106), referred to herein a “processor.” In various embodiments, the computing devices 102, 104, 106 may be participants in, and may communicate via, a distributed context network. While the method 500 is illustrated involving two computing devices 502 and 504 for clarity, additional computing devices also may perform one or more of the operations described below.

In some embodiments, the computing device 502 may store 506 content to a copy buffer in the first computing device 502. In some embodiments, the content may be associated with a user key and an encrypted content address.

The second computing device 504 may receive the user key. In some embodiments, the second computing device 504 may receive the user key in a message 508a from the first computing device 502. For example, the first computing device 502 may send a message to the second computing device 504 granting the second computing device 504 authorization or permission to access the content stored in the copy buffer in the first computing device 502. In some embodiments, the second computing device 504 may receive the user key in an input 508b to an input device of the second computing device 504. For example, the second computing device 504 may receive biometric information (e.g., via a fingerprint reader, camera, or another suitable device), a PIN code or a password (e.g., via a physical or virtual keyboard), or other suitable information.

The first computing device 502 may send an indication of the content stored in the copy buffer of the first computing device 502 in state information 510. In some embodiments, computing devices connected to the distributed context network may send state information to other computing devices connected to the distributed context network from time to time.

The second computing device 504 may present a user interface in operation 512 that indicates the content stored in the copy buffer in the first computing device 502. In some embodiments, the second computing device 504 may be configured to present in the user interface only content associated with the received user key. For example, having received the user key associated with the content stored in the copy buffer in the first computing device 502, the second computing device 504 may present the indication of the content stored in the copy buffer of the first computing device 502. However, even if the second computing device 504 receives state information indicating content stored in a copy buffer in a third computing device (not illustrated), if the second computing device 504 has not received a user key associated with the content stored in the copy buffer in the third computing device, the second computing device 504 will not present an indication of the content stored in the copy buffer in the third computing device.

The second computing device 504 may receive 514 an input indicating selected content from among the content of the copy buffer in the first computing device 504. The second computing device 504 may send a request 516 to the first computing device for the selected content. In some embodiments, the request 516 may include the received user key in a manner that is configured to enable the first computing device 502 to perform an authentication operation using the user key in the request 516.

The first computing device 504 may perform 518 and authentication operation using the purported user key in the message 516, and the user key associated with the selected content in the copy buffer of the first computing device 502.

In some embodiments, in response to performing the authentication successfully, the first computing device 502 may send to the second computing device 504 an authentication success message 520. In some embodiments, the authentication success message 520 may include information configured to enable the second computing device 504 to decrypt the encrypted content address associated with the selected content.

The second computing device 504 may decrypt the encrypted content address in operation 522 using the information received in the authentication success message 520. The second computing device 504 may perform an access attempt 524 to obtain the selected content. In some embodiments, the access attempt 524 may include a request message or access request message including the decrypted content address that the second computing device 504 sends to the first computing device 502. In some embodiments, the decrypted content address may be configured to enable the second computing device 504 to directly access the selected content in the copy buffer in the first computing device 502.

The second computing device 504 may receive 526 the selected content from the first computing device 502 in response to the access attempt 524.

The second computing device 504 may perform an operation 528 using the received selected content. In some embodiments, the second computing device 504 may store the received selected content. In some embodiments, the second computing device 504 may present the received selected content via a user interface (e.g., displaying the received content, playing an audio portion of the received content, etc.).

In some embodiments, in response to performing the authentication successfully, the first computing device 502 may decrypt 530 the encrypted content address associated with the selected content and access the selected content. The first computing device 502 may send the selected content 532 to the second computing device 504. Similar to operation 528 as described, the second computing device 504 may perform an operation 534 using the received selected content.

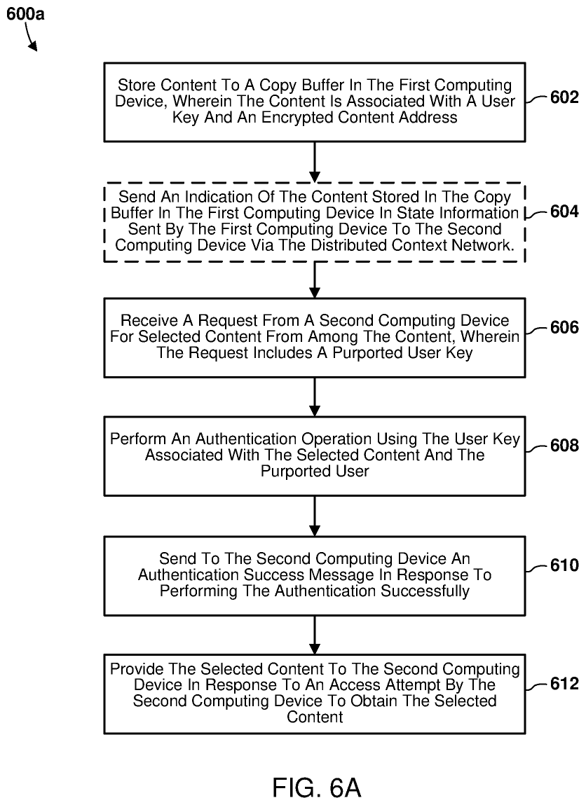

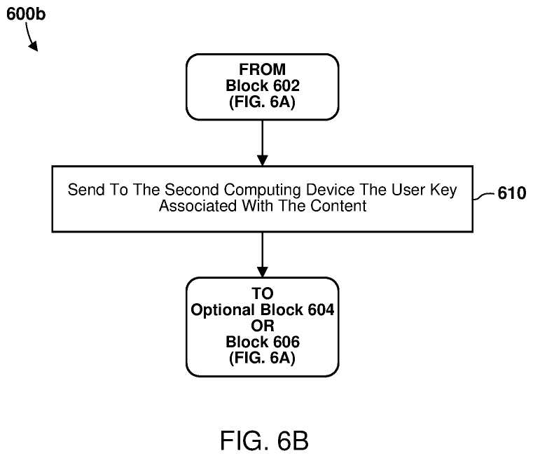

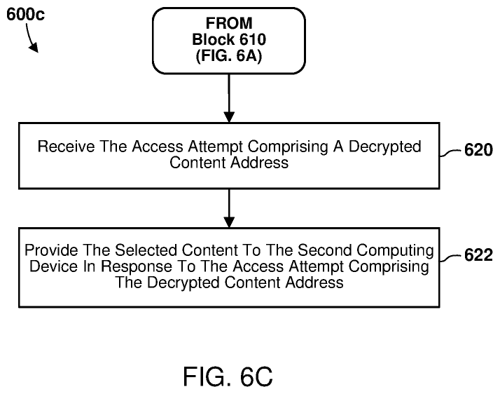

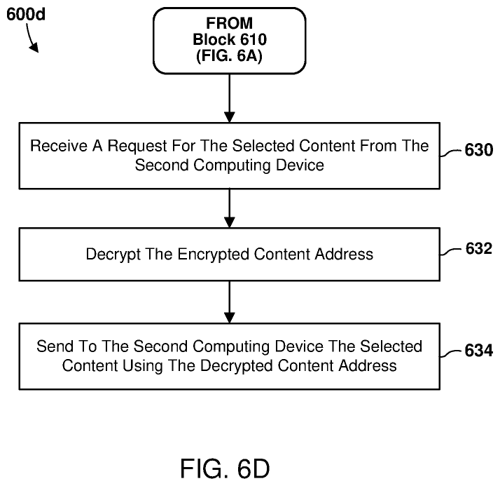

FIG. 6A is a process flow diagram illustrating a method 600a that may be performed by a processing device of a computing device (e.g., 102) for managing access to content in a distributed context network in accordance with various embodiments. With reference to FIGS. 1-6A, means for performing each of the operations of the method 600a may include a processor (e.g., 202, 204, 210, 212, 214, 216, 218, 260, 310) of the computing device (e.g., 102), referred to herein as a “processor.”

In block 602, the processor may store (e.g., past or copy) content to a copy buffer in the first computing device, with the content associated with a user key and an address for the content in the copy buffer. In some embodiments, the content address may be encrypted.

In optional block 604, the processor may send sending an indication of the content stored in the copy buffer in the first computing device in state information sent by the first computing device to the second computing device via the distributed context network.

In block 606, the processor may receive a request from a second computing device for selected content from among the content, wherein the request includes a purported user key. The purported user key is an identifier that corresponds to the user that created the file or content that is in the copy buffer to of the first computing device, such as by pasting or otherwise copying a file into the copy buffer. As described, the purported user key may be any form of identifier that is unique to each user on or known to the distributed context network.

In block 608, the processor may perform an authentication operation using the user key associated with the selected content and the purported user key. For example, the processor may compare the user key to a database of user keys known to the distributed context network, and authenticate the purported user key if there is a match. Other forms of key authentication may be used to provide greater levels of security to the network.

In block 610, the processor may send to the second computing device an authentication success message in response to performing the authentication successfully. In some embodiments, the authentication success measured may include information configured to enable the second computing device to decrypt the encrypted content address.

In block 612 the processor may provide the selected content to the second computing device in response to an access attempt by the second computing device to obtain the selected content. In some embodiments, the operations in block 612 may include providing the second computing device with authorization, information or other mechanism for directly accessing the copy buffer of the first computing device via the distributed context network. In some embodiments, the operations in block 612 may include the second computing device sending a request to first computing device via the distributed context network identifying the file to be provided from the copy buffer, in response to which the first computing device sends the requested file from the copy buffer to the second computing device via the distributed context network.

FIGS. 6B-6D are process flow diagrams illustrating example operations 600b-600d that may be performed by a processing device of a computing device as part of the method 600a for managing access to content in a distributed context network in accordance with various embodiments. With reference to FIGS. 1-6D, means for performing each of the operations 600b-600d may include a processor (e.g., 202, 204, 210, 212, 214, 216, 218, 260, 310) of the computing device (e.g., 102), referred to herein as a “processor.”

Referring to FIG. 6B, after the processor stores content to a copy buffer in the first computing device in block 602, the processor may send to the second computing device the user key associated with the content in block 610. In some embodiments the processor may send to the second computing device a message granting permission or access to the second computing device to view the content stored in the copy buffer in the (first) computing device. In some embodiments, the processor may send the user key associated with the content to the second computing device in the indication of content stored in the copy buffer, or associated with the indication of the content stored in the copy buffer in the first computing device.

The processor may then perform the operations of optional block 604 or block 606 of the method 600a as described.

Referring to FIG. 6C, after the processor sends to the second computing device an authentication success message in response to performing the authentication successfully in block 610, the processor may receive the access attempt from the second computing device in block 620. In some embodiments, the access attempt may include a decrypted content address.

In block 622, the processor may provide the selected content to the second computing device in response to the access attempt comprising the decrypted content address.

Referring to FIG. 6D, after the processor sends to the second computing device an authentication success message in response to performing the authentication successfully in block 610, the processor may receive a request for the selected content from the second computing device in block 630.

In block 632, the processor may decrypt the encrypted content address.

In block 634, the processor may use the decrypted content address to obtain the selected content from the copy buffer and then send the selected content to the second computing device via the distributed context network.

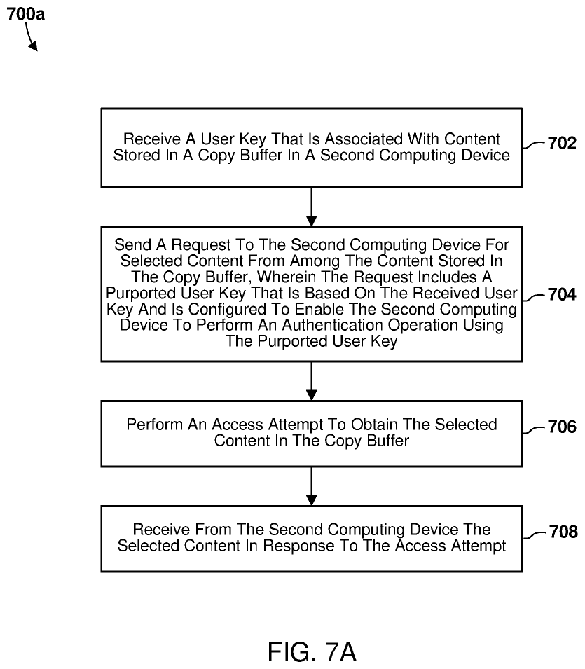

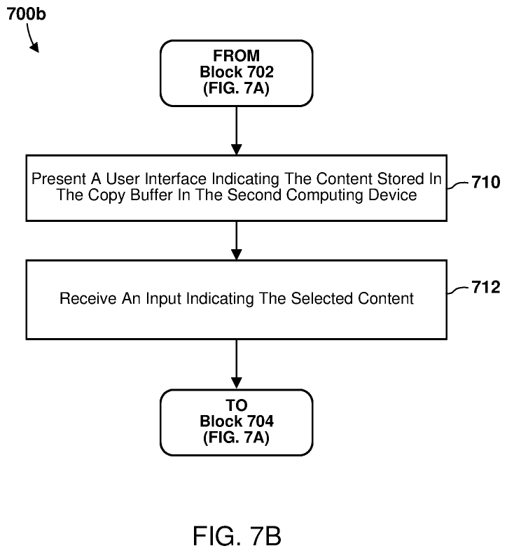

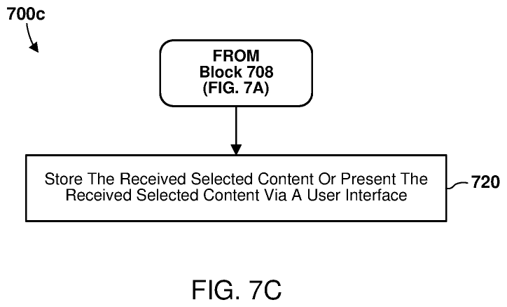

FIG. 7A is a process flow diagrams illustrating a method 700a that may be performed by a processing device of a computing device (e.g., 104, 106) for managing access to content in a distributed context network in accordance with various embodiments. With reference to FIGS. 1-7A, means for performing each of the operations of the method 700a may include a processor (e.g., 202, 204, 210, 212, 214, 216, 218, 260, 310) of the computing device (e.g., 104, 106), referred to herein as a “processor.”

In block 702, the processor may receive a user key that is associated with content stored in a copy buffer in a second computing device. In some embodiments, the processor may receive the user key in a message from the second computing device. In some embodiments, the processor may receive the user key via a user input to the first computing device.

In block 704, the processor may send a request to the second computing device for selected content from among the content stored in the copy buffer, in which the request includes a purported user key that is based on the received user key and is configured to enable the second computing device to perform an authentication operation using the purported user key.

In block 706, the processor may perform an access attempt to obtain the selected content in the copy buffer.

In block 708, the processor may receive from the second computing device the selected content in response to the access attempt.

FIGS. 7B and 7C are process flow diagrams illustrating example operations 700b and 700c that may be performed by a processing device of a computing device as part of the method 700a for managing access to content in a distributed context network in accordance with various embodiments. With reference to FIGS. 1-7B means for performing each of the operations 700b may include a processor (e.g., 202, 204, 210, 212, 214, 216, 218, 260, 310) of the computing device (e.g., 104, 106), referred to herein as a “processor.”

Referring to FIG. 7B, after receiving a user key that is associated with content stored in a copy buffer in a second computing device in block 702 of the method 700a, the processor may present a user interface indicating the content stored in the copy buffer in the second computing device in block 710.

In block 712, the processor may receive an input (e.g., via the user interface, an input device, etc.) indicating the selected content.

The processor may then send a request via the distributed context network to the second computing device for selected content from among the content stored in the copy buffer in block 704 of the method 700a as described.

Referring to FIG. 7C, after receiving from the second computing device the selected content in response to the access attempt in block 708 of the method 700a, the processor may store the received selected content or present the received selected content via a user interface in block 720. For example, the processor may store the received selected content in a memory of the (first) computing device, and/or may present the selected content via a display device, a speaker, or another suitable output device of the computing device.

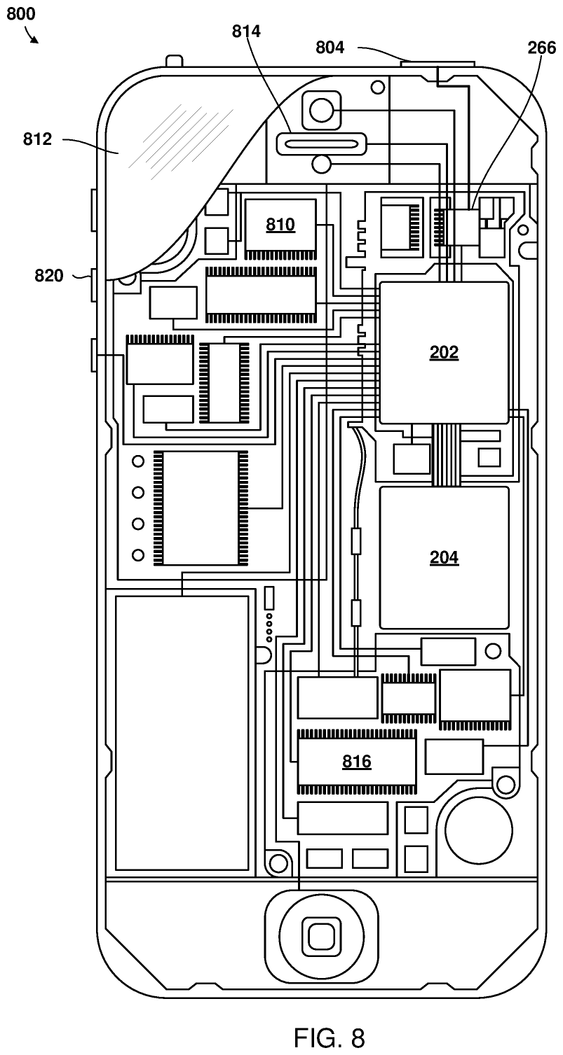

FIG. 8 is a component block diagram of an example computing device suitable for use with various embodiments. With reference to FIGS. 1-8, in some embodiments, the computing device (e.g., 102, 104, 106) may be implemented in the form of a smart phone 800. In various embodiments, the smart phone 800 may be configured to perform the operations of the methods and operations 500, 600a-600d, and 700a-700c.

The smart phone 800 may include a first SOC 202 (e.g., a SOC-CPU) coupled to a second SOC 204 (e.g., a 5G capable SOC). The first and second SOCs 202, 204 may be coupled to internal memory 816, a display 812, and to a speaker 814. Additionally, the smart phone 800 may include an antenna 804 for sending and receiving electromagnetic radiation that may be connected to a wireless data link and/or cellular telephone transceiver 266 coupled to one or more processors in the first and/or second SOCs 202, 204. The smart phone 800 may also include menu selection buttons or rocker switches 820 for receiving user inputs.

The smart phone 800 also may include a sound encoding/decoding (CODEC) circuit 810, which digitizes sound received from a microphone into data packets suitable for wireless transmission and decodes received sound data packets to generate analog signals that are provided to the speaker to generate sound. Also, one or more of the processors in the first and second SOCs 202, 204, wireless transceiver 266 and CODEC 810 may include a digital signal processor (DSP) circuit (not shown separately).

The processors of the smart phone 800 may be any programmable microprocessor, microcomputer or multiple processor chip or chips that can be configured by software instructions (applications) to perform a variety of functions, including the functions of the various embodiments described below. In some mobile devices, multiple processors may be provided, such as one processor within an SOC 204 dedicated to wireless communication functions and one processor within an SOC 202 dedicated to running other applications. Software applications may be stored in the memory 816 before they are accessed and loaded into the processor. The processors may include internal memory sufficient to store the application software instructions.

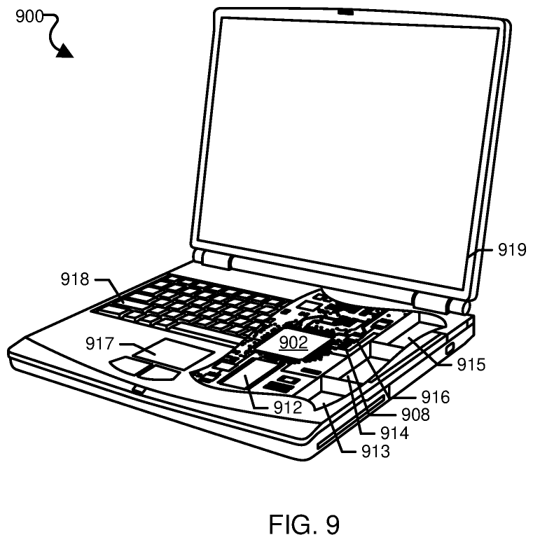

FIG. 9 is a component block diagram of an example computing device suitable for use with various embodiments. With reference to FIGS. 1-9, in some embodiments, the computing device (e.g., 102, 104, 106) may be implemented in the form of a laptop computer 900. In various embodiments, the laptop computer 900 may be configured to perform the operations of the methods and operations 500, 600a-600d, and 700a-700c.

In various embodiments, the laptop computer 900 may include a touchpad (or trackpad) touch surface 917 that serves as the computer's pointing device, and thus may receive pinch in, pinch out, drag, scroll, flick gestures, etc. similar to those that may be implemented on computing devices equipped with a touch screen display. The laptop computer 900 may include a processor 902 coupled to volatile memory 912 and a large capacity nonvolatile memory, such as a disk drive 913 of Flash memory. Additionally, the laptop computer 900 may include one or more antenna 908 for sending and receiving electromagnetic radiation that may be connected to a wireless data link and/or cellular telephone transceiver 916 coupled to the processor 902. The laptop computer 900 may also include a transceiver 914 implementing short range wireless communication using a variety of short-range communication protocols, such as any of the Institute of Electrical and Electronics Engineers (IEEE) 802.11 and 802.15 protocols. The laptop computer 900 also may include a compact disc (CD) drive 915 coupled to the processor 902. The laptop computer 900 may include a touchpad 917, a keyboard 918, and a display 919 all coupled to the processor 902. Other configurations of the laptop computer 900 may include a computer mouse or trackball coupled to the processor (e.g., via a Universal Serial Bus (USB) input) as are well known, which may also be used in conjunction with various embodiments.

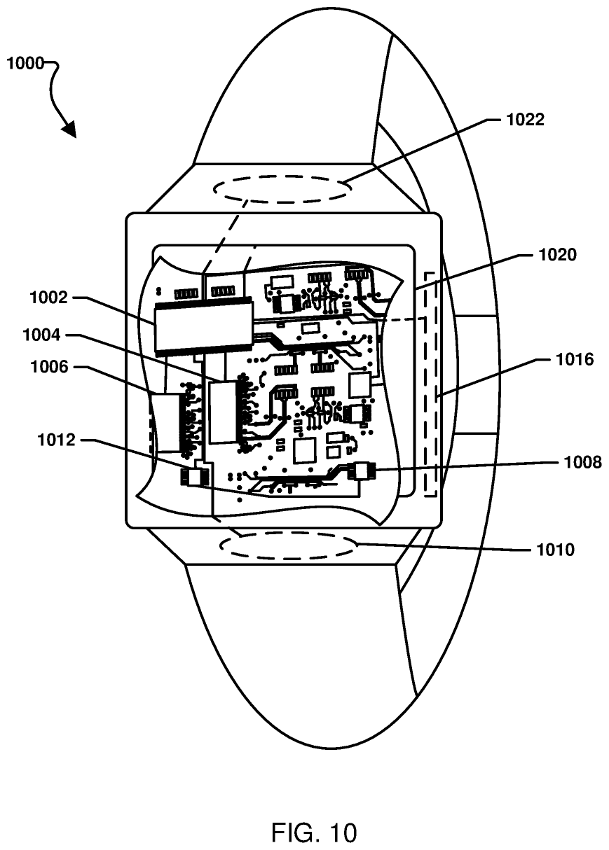

FIG. 10 is a component block diagram of an example computing device suitable for use with various embodiments. With reference to FIGS. 1-10, in some embodiments, the computing device (e.g., 102, 104, 106) may be implemented in the form of a smart watch 1000. In various embodiments, the smart watch 1000 may be configured to perform the operations of the methods and operations 500, 600a-600d, and 700a-700c.

The smart watch 1000 may include an SoC 1002 including two or more processors (e.g., application processor, low power processor) coupled to internal memories 1004 and 1006. Internal memories 1004, 1006 may be volatile or non-volatile memories, and may also be secure and/or encrypted memories, or unsecure and/or unencrypted memories, or any combination thereof. The SoC 1002 may also be coupled to a touchscreen display 1020, such as a resistive-sensing touchscreen, capacitive-sensing touchscreen infrared sensing touchscreen, or the like. Additionally, the smart watch 1000 may have one or more antenna 1008 for sending and receiving electromagnetic radiation that may be connected to one or more wireless data links 1012, such as one or more Bluetooth® transceivers that may be coupled to the SoC 1002.

The smart watch 1000 may also include physical and/or virtual buttons 1022 and 1010 for receiving user inputs as well as a slide sensor 1016 for receiving user inputs. The touchscreen display 1020 may be coupled to a touchscreen interface module that is configured receive signals from the touchscreen display 1020 indicative of locations on the screen where a user's fingertip or a stylus is touching the surface and output to the SoC 1002 information regarding the coordinates of touch events. The physical and/or virtual buttons 1022 and touchscreen display 1020 may be configured to receive an input such as pinch in, pinch out, drag, scroll, flick gestures, etc. Further, the SoC 1002 may be configured with processor-executable instructions to correlate images presented on the touchscreen display 1020 with the location of touch events received from the touchscreen interface module in order to detect when a user has interacted with a graphical interface icon, such as a virtual button.

The SoC 1002 may be any programmable microprocessor, microcomputer or multiple processor chip or chips that can be configured by software instructions (applications) to perform a variety of functions, including the functions of various embodiments. In some devices, multiple processors may be provided, such as one processor dedicated to wireless communication functions and one processor dedicated to running other applications. Typically, software applications may be stored in an internal memory before they are accessed and loaded into the SoC 1002. The SoC 1002 may include internal memory sufficient to store the application software instructions. In many devices the internal memory may be a volatile or nonvolatile memory, such as flash memory, or a mixture of both. For the purposes of this description, a general reference to memory refers to memory accessible by the SoC 1002 including internal memory or removable memory plugged into the wearable device and memory within the SoC 1002 itself.

The processors of the smart phone 800, the laptop computer 900, and the smart watch 1000 may be any programmable microprocessor, microcomputer, or multiple processor chip or chips that can be configured by software instructions (applications) to perform a variety of functions, including the functions of various embodiments described. In some computing devices, multiple processors may be provided, such as one processor within first circuitry dedicated to wireless communication functions and one processor within second circuitry dedicated to running other applications. Software applications may be stored in the memory before they are accessed and loaded into the processor. The processors may include internal memory sufficient to store the application software instructions.

Implementation examples are described in the following paragraphs. While some of the following implementation examples are described in terms of example methods, further example implementations may include: the example methods discussed in the following paragraphs implemented by a computing device comprising a processor configured with processor-executable instructions to perform operations of the methods of the following implementation examples; the example methods discussed in the following paragraphs implemented by a computing device comprising means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1. A method of managing access to content in a distributed context network, including: storing, by a first computing device, content to a copy buffer in the first computing device, wherein the content is associated with a user key and an encrypted content address; receiving a request from a second computing device for selected content from among the content, wherein the request includes a purported user key; performing an authentication operation, by the first computing device, using the user key associated with the selected content and the purported user key; sending to the second computing device an authentication success message in response to performing the authentication successfully; and providing the selected content to the second computing device in response to an access attempt by the second computing device to obtain the selected content.

Example 2. The method of example 1, further including sending to the second computing device the user key associated with the content.

Example 3. The method of either of examples 1 or 2, wherein the authentication success message further includes information configured to enable the second computing device to decrypt the encrypted content address.

Example 4. The method of example 3, wherein providing the selected content to the second computing device in response to the access attempt by the second computing device to obtain the selected content includes: receiving the access attempt including a decrypted content address; and providing the selected content to the second computing device in response to the access attempt including the decrypted content address.

Example 5. The method of any of examples 1-5, wherein providing the selected content to the second computing device in response to the access attempt by the second computing device to obtain the selected content includes: receiving a request for the selected content from the second computing device; decrypting the encrypted content address; sending to the second computing device the selected content using the decrypted content address.

Example 6. The method of any of examples 1-5, further including sending an indication of the content stored in the copy buffer in the first computing device in state information sent by the first computing device to the second computing device via the distributed context network.

Example 7. A method of managing access to content in a distributed context network, including: receiving, by a first computing device, a user key that is associated with content stored in a copy buffer in a second computing device; sending a request to the second computing device for selected content from among the content stored in the copy buffer, wherein the request includes a purported user key that is based on the received user key and is configured to enable the second computing device to perform an authentication operation using the purported user key; performing an access attempt to obtain the selected content in the copy buffer; and receiving from the second computing device the selected content in response to the access attempt.

Example 8. The method of claim 7, wherein receiving the user key that is associated with the content stored in the copy buffer in the second computing device includes receiving the user key in a message from the second computing device.

Example 9. The method of either of examples 7 or 8, wherein receiving the user key that is associated with the content stored in the copy buffer in the second computing device includes receiving the user key via a user input to the first computing device.

Example 10. The method of any of examples of 7-9, further including: presenting a user interface indicating the content stored in the copy buffer in the second computing device; and receiving by the first computing device an input indicating the selected content.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the spirit or scope of the claims. Thus, the present disclosure is not intended to be limited to the embodiments shown herein but is to be accorded the widest scope consistent with the following claims and the principles and novel features disclosed herein.

What is claimed is:

1. A method of managing access to content in a distributed context network, comprising:
storing, by a first computing device, content to a copy buffer in the first computing device, wherein the content is associated with a user key and an encrypted content address;
receiving a request from a second computing device for selected content from among the content, wherein the request includes a purported user key;
performing an authentication operation, by the first computing device, using the user key associated with the selected content and the purported user key;
sending to the second computing device an authentication success message in response to performing the authentication successfully; and
providing the selected content to the second computing device in response to an access attempt by the second computing device to obtain the selected content.

2. The method of claim 1, further comprising sending to the second computing device the user key associated with the content.

3. The method of claim 1, wherein the authentication success message further comprises information configured to enable the second computing device to decrypt the encrypted content address.

4. The method of claim 3, wherein providing the selected content to the second computing device in response to the access attempt by the second computing device to obtain the selected content comprises:
receiving the access attempt comprising a decrypted content address; and
providing the selected content to the second computing device in response to the access attempt comprising the decrypted content address.

5. The method of claim 1, wherein providing the selected content to the second computing device in response to the access attempt by the second computing device to obtain the selected content comprises:
receiving a request for the selected content from the second computing device;
decrypting the encrypted content address; and
sending to the second computing device the selected content using the decrypted content address.

6. The method of claim 1, further comprising sending an indication of the content stored in the copy buffer in the first computing device in state information sent by the first computing device to the second computing device via the distributed context network.

7. A computing device, comprising:
a wireless transceiver configured to communicate with a distributed context network;
a memory including a copy buffer; and
a processor coupled to the wireless transceiver and memory, and configured to:
store content to a copy buffer in the first computing device, wherein the content is associated with a user key and an encrypted content address;
receive a request from a second computing device for selected content from among the content, wherein the request includes a purported user key;
perform an authentication operation, by the first computing device, using the user key associated with the selected content and the purported user key;
send to the second computing device an authentication success message in response to performing the authentication successfully; and
provide the selected content to the second computing device in response to an access attempt by the second computing device to obtain the selected content.

8. The computing device of claim 7, wherein the processor is further configured to send to the second computing device the user key associated with the content.

9. The computing device of claim 7, wherein the processor is further configured such that the authentication success message further comprises information configured to enable the second computing device to decrypt the encrypted content address.

10. The computing device of claim 9, wherein the processor is further configured to provide the selected content to the second computing device in response to the access attempt by the second computing device to obtain the selected content by:
receiving the access attempt comprising a decrypted content address; and
providing the selected content to the second computing device in response to the access attempt comprising the decrypted content address.

11. The computing device of claim 7, wherein the processor is further configured to provide the selected content to the second computing device in response to the access attempt by the second computing device to obtain the selected content by:
receiving a request for the selected content from the second computing device;
decrypting the encrypted content address; and
sending to the second computing device the selected content using the decrypted content address.

12. The computing device of claim 7, wherein the processor is further configured to send an indication of the content stored in the copy buffer in the first computing device in state information sent by the first computing device to the second computing device via the distributed context network.

13. A method of managing access to content in a distributed context network, comprising:
receiving, by a first computing device, a user key that is associated with content stored in a copy buffer in a second computing device;
sending a request to the second computing device for selected content from among the content stored in the copy buffer, wherein the request includes a purported user key that is based on the received user key and is configured to enable the second computing device to perform an authentication operation using the purported user key;
performing an access attempt to obtain the selected content in the copy buffer; and
receiving from the second computing device the selected content in response to the access attempt.

14. The method of claim 13, wherein receiving the user key that is associated with the content stored in the copy buffer in the second computing device comprises receiving the user key in a message from the second computing device.

15. The method of claim 13, wherein receiving the user key that is associated with the content stored in the copy buffer in the second computing device comprises receiving the user key via a user input to the first computing device.

16. The method of claim 13, further comprising:
presenting a user interface indicating the content stored in the copy buffer in the second computing device; and
receiving by the first computing device an input indicating the selected content.

17. The method of claim 13, further comprising storing the received selected content or presenting the received selected content via a user interface.

18. A computing device, comprising:
a wireless transceiver configured to communicate with a distributed context network;
a memory including a copy buffer; and
a processor coupled to the wireless transceiver and memory, and configured to:
receive a user key that is associated with content stored in a copy buffer in a second computing device;
send a request to the second computing device for selected content from among the content stored in the copy buffer, wherein the request includes a purported user key that is based on the received user key and is configured to enable the second computing device to perform an authentication operation using the purported user key;
perform an access attempt to obtain the selected content in the copy buffer; and
receiving from the second computing device the selected content in response to the access attempt.

19. The computing device of claim 18, wherein the processor is further configured to receive the user key in a message from the second computing device.

20. The computing device of claim 18, wherein the processor is further configured to receive the user key via a user input to the computing device.

21. The computing device of claim 18, wherein the processor is further configured to:
present a user interface indicating the content stored in the copy buffer in the second computing device; and
receive an input indicating the selected content.

22. The computing device of claim 18, comprising storing the received selected content or presenting the received selected content via a user interface.
